(19) United States
(12) Patent Application Publication
(10) Pub. No.: US 2026/0300364 A1
(43) Pub. Date: Oct. 1, 2026

(54) DECISION ARCHITECTURE TO SELECT THE BEST SUMMARIZATION STRATEGIES FOR CONTEXT MANAGEMENT

(71) Applicant: Dell Products L.P., Round Rock, TX (US)

(72) Inventors: Diego Vrague Noble, Pelotas (BR); Ítalo Gomes Santana, Rio de Janeiro (BR); Miguel Paredes Quiñones, Campinas (BR); Roberto Nery Stelling Neto, Rio de Janeiro (BR); Vicente J.P. Amorim, João Monlevade (BR)

(21) Appl. No.: 19/093,210

(22) Filed: Mar. 27, 2025

(51) Int. Cl. G06F 16/34; G06F 16/353

(52) U.S. Cl. CPC G06F 16/345; G06F 16/353

(57) ABSTRACT

One example method includes receiving input data, splitting the input data into a set of semantic chunks, for each of the semantic chunks, performing operations including: extracting features from the semantic chunk; using the features to perform an ML (machine learning) inferencing process that identifies a summarization strategy for summarizing the semantic chunk based on the features; and, applying the summarization strategy to the semantic chunk to obtain a summary of the semantic chunk. The method further includes combining the respective summaries of each of the semantic chunks so as to define an overall context of the input data.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to ML (machine learning) models such as LLMs (large language models). More particularly, at least some embodiments relate to systems, hardware, software, computer-readable media, and methods, for processing a context input to an LLM such that the context input fits with defined input constraints.

### BACKGROUND

Large Language Models (LLMs) have been uncovering many potential uses cases, such as the application of these models to work as chatbots, for example, ChatGPT by OpenAI, and Co-pilot 360 by Microsoft. Recently, there have been substantial interest in using these chatbots to perform tasks outside the scope of the chat interface using autonomous agents, which may be integrated with internet search engines for example, or to interact with multi-modal sources such as documents, audio, and video.

One open problem with LLMs is that they have limitations on the size of the input they can take. This size is typically measured by the number of tokens that the LLM can process at each interaction, with values usually ranging in the thousands of tokens. The input composition to LLMs varies from model to model but, in general, is composed of [i] the query made by user, [ii] information about previous interactions between the LLM and user(s), that is, the context, and [iii] other side instructions—for example “Be succinct and friendly when answering and avoid making things up.”—to enhance the quality of the LLM output.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture of a RAG-based approach, according to one embodiment.

FIG. 2 discloses aspects of an example RAG prompt, according to one embodiment.

FIG. 3 discloses an overview of a schema, according to one embodiment.

FIG. 4 discloses aspects of a method, according to one embodiment.

FIG. 5 discloses an example of splitting an input into two independent semantic chunks, according to one embodiment.

FIG. 6 discloses an example of a ML (machine learning) predictor flow in which two chunks are independently embedded and classified—in this example, the classifier results are two different context summarization strategies, according to one embodiment.

FIG. 7 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to ML (machine learning) models such as LLMs (large language models). More particularly, at least some embodiments relate to systems, hardware, software, computer-readable media, and methods, for processing a context input to an LLM such that the context input fits with defined input constraints.

Example embodiments comprise methods, architectures, and schemas, for processing inputs, which may comprise context inputs, to an LLM. In an embodiment, the inputs are processed before they are actually input to the LLM.

A method according to one example embodiment may comprise operations including, but not limited to: using a splitter to break up an LLM input into a set of k self-contained chunks of information; for each of the self-contained chunks, performing one of the following processes: [a] for a ‘server only’ mode, extracting and encoding features of the chunk for an ML inferencing process; performing an inferencing process to identify and select a best strategy, as among a group of possible strategies, for summarizing texts based on features present in contents of the texts; and, applying the best strategy to the chunk; [b] for a ‘fully distributed’ mode, transmitting the chunk to an edge device; at the edge device, extracting and encoding features of the chunk for an ML inferencing process; performing an inferencing process to identify and select a best strategy, as among a group of possible strategies, for summarizing texts based on features present in contents of the texts; and, applying the best strategy to the chunk; or [c] for a ‘mixed’ mode, performing a combination of the ‘server only’ mode process and the ‘fully distributed’ mode process; and, executing a combinator on respective results of the three processes to produce a shorter but meaningful description of all chunks enriched by the previous context.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a contextualized summarization may be implemented that may be modified according to various constraints. An embodiment may provide a flexible pipeline based architecture that may be modified, possibly automatically, according to the granularity of the chunks that make up the context input. An embodiment may provide an infrastructure-aware summarization architecture that may leverage a splitter/chunk generation process to determine a level of parallelism that will be employed. Various other advantages of one or more example embodiments will be apparent from this disclosure.

### A. REFERENCES

Reference is made herein to various documents, listed below. These are incorporate herein in their respective entireties by this reference.
[1]R. Girdhar et al., “ImageBind: One Embedding Space To Bind Them All,” May 31, 2023, arXiv: arXiv:2305.05665. doi: 10.48550/arXiv.2305.05665.
[2]P. Szymanski and T. Kajdanowicz, “A scikit-based Python environment for performing multi-label classification,” Dec. 10, 2018, arXiv: arXiv:1702.01460. doi: 10.48550/arXiv.1702.01460.
[3]“scikit-multilearn|Multi-label classification package for python.” Accessed: Jul. 18, 2024. [Online]. Available: http://scikit.ml/multilabelembeddings.html.
[4]S. Luo, Y. Yang, and M. Song, “DeepSIC: Deep Semantic Image Compression,” Jan. 29, 2018, arXiv: arXiv:1801.09468. Accessed: Mar. 16, 2023. [Online]. Available: http://arxiv.org/abs/1801.09468.
[5] Li, Huayang, et al. “A survey on retrieval-augmented text generation.” arXiv preprint arXiv:2202.01110 (2022).
[6] Asai, Akari, et al. “Self-rag: Learning to retrieve, generate, and critique through self-reflection.” The Twelfth International Conference on Learning Representations. 2023.
[7] https://python.langchain.com/v0.1/docs/modules/memory/multiple_memory/.
[8] https://github.com/FullStackRetrieval-com/RetrievalTutorials/blob/main/tutorials/LevelsOfTextSplitting/5_Levels_Of_Text_Splitting.ip ynb.
[9] Chen, L. and Varoquaux, G., 2024. What is the role of small models in the LLM era: A survey. arXiv preprint arXiv:2409.06857.
[10] The Ultimate Guide to Fine-Tuning LLMs from Basics to Breakthroughs: An Exhaustive Review of Technologies, Research, Best Practices, Applied Research Challenges and Opportunities (Version 1.0) https://arxiv.org/html/2408.13296v1.

### B. Aspects of an Example Context for One Embodiment

The following is a discussion of aspects of an example context for one or more embodiments. This discussion is not intended to limit the scope of the claims or this disclosure, or the applicability of the embodiments, in any way.

An LLM is a type of Artificial Intelligence (AI) model trained on a large corpus of text data that enables generative text tasks. Models of this kind are useful for producing articles, summarization, translation, question and answering, paraphrasing, among many others, underpinning, and sometimes replacing, human-written texts. Further information is available in [1].

One or more example embodiments leverage existing approaches for building LLM-based chatbots, improving them with optimized and automatic strategies to decide when it is necessary to update the context data during a conversation. Conversational LLMs are important when implementing conversation-based chatbots. As suggested by their name, the largest and most advanced of these models often have billions of parameters, requiring a powerful computational infrastructure to train and serve them on-premises. Fortunately, the full training step of LLMs can be mitigated, or even avoided, by the approaches described in the following subsections.

Example embodiments may be applied to conversational solutions that use a Retrieval Augmented Generation (RAG)-based or similar architecture, that is, an architecture that contemplates a domain-specific Knowledge Base (KB) from which the sources are fetched out and used by the LLM as the base context from where the answer is elaborated. In the following subsections, brief descriptions of various concepts are presented that may be useful to an understanding of the disclosed embodiments.

### B.1 Fine-Tuning Pre-Trained Models

Existing pre-trained foundational models, trained on specific/general datasets, can be fine-tuned, as disclosed in [4] and [10], with niche-specific data without requiring full (re)training. In this case, domain-specific information can be used to update models' internal weights, making them aware of intrinsic patterns existing in a set. There may be various pros and cons that attend the use of such an approach.
Pros: This is a more feasible and resource less-intensive approach when compared to full training from scratch, resulting in significantly less time to make the model able to tackle specific tasks.
Cons: Domain-specific solutions, which require the usage of private/classified data demand additional fine-tuning rounds every time the content is changed. The frequency of updates can make this approach costly and prohibitive. Additionally, hardware requirements generate a prohibitive cost on-premises finetuning. Also, semantic search, that is, used for search related content, sometimes can provide nonrelated content and ultimately affect the LLM answer.

### B.2 Retrieval-Augmented Generation (RAG)

As discussed in [5] and [6], RAG is an approach that leverages KBs as a repository of domain-specific data that can be searched and retrieved by the LLM. Rather than retraining or fine-tuning the model, the KB acts as a repository from which the LLM fetches updated data to support its interactions with the end-user, as in the case of a text generation proxy. In this case, domain-specific data can be updated at any frequency, without impacting on the infrastructure requirements. This fetched data is then joined in the prompt with the user question. There may be various pros and cons that attend the use of such an approach.
Pros: It is a lightweight and less-intensive approach when compared to fine-tunning once the model does not need to be retrained. The general architecture allows the continuous update of sources without having to stop the whole pipeline. Additionally, sources used to answer a question can be tracked down, providing more transparency and accountability to the end user. Caching can exploit documents with high frequency retrieval.
Cons: As RAG does not use a fine-tuning approach, complex patterns and intrinsic relationships cannot be created as easily as in the fine-tuning process. Therefore, external approaches must be “manually” used to improve the solution.

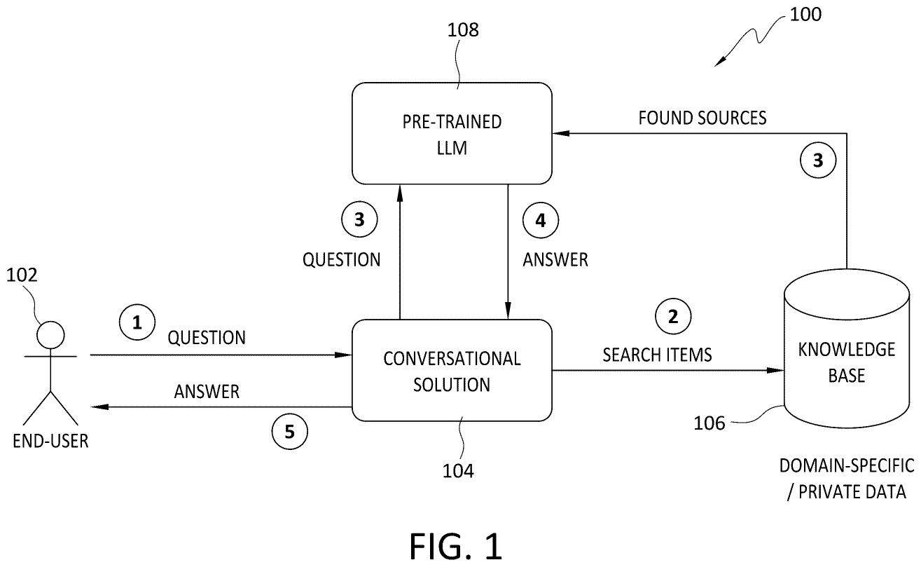

FIG. 1 discloses an architectural overview 100 of the components a typical RAG-based solution has. To answer a given question, such as may be received from a human user by a chatbot or other digital assistant, the following operations may be executed:
1. The user 102 issues a question to the “Conversational Solution” (CS) end 104;
2. The CS 104 may pre-process the user question and look for related sources on a KB infrastructure 106. Depending on how it is implemented, this operation might demand a significant amount of computational resources, increasing the cost of the whole solution;
3. Both “retrieved sources” and “user question” are sent to the LLM 108. Sources are used as the context in which the LLM 108 will anchor the generation of the answer to the user question;
4. The LLM 108 sends the generated answer back to the CS 104, which performs any required post-processing on the answer; and
5. Generated and post-processed answers are sent back to the end-user 102 by the CS 104.

### B.3 why the Context Data Matters

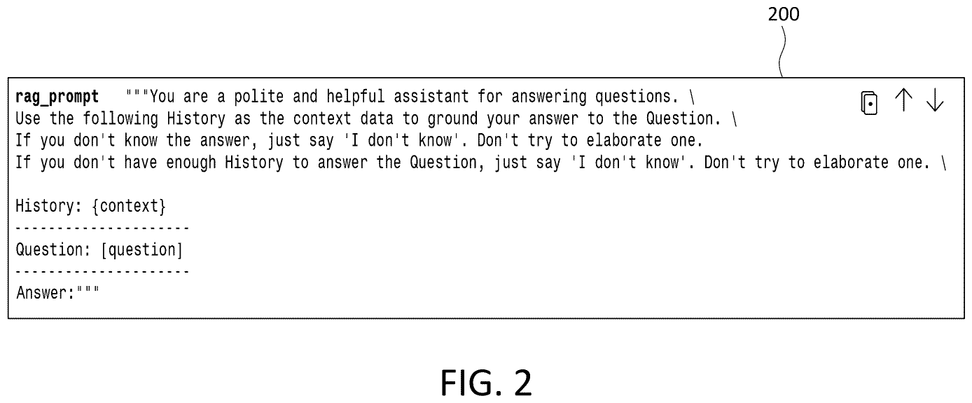

As disclosed in the example of FIG. 1, the CS oversees orchestration of the components of a RAG-based solution. In operation (3), FIG. 1 provides an insight as to how the LLM 108 uses the sources to generate the answer. For this part, the LLM 108 ingests the sources as the ground truth where the definitive answer should be anchored to. Currently, regardless of the LLM 108 and the KB 106 in use, the operation (3) could have its general form as the one disclosed in FIG. 2. The RAG prompt 200 disclosed in FIG. 2 initially gives a general description to the LLM 108, including directives and restrictions of how the LLM 108 may behave when generating answers. Likewise, the {context}tag has a special place on this type of construction, once it is used as the entry point to ingest context data loaded from the KB 106. In this way, the CS 104 can ground the answers on facts, forcing the LLM 108 to avoid hallucinations. Additionally, this same approach also enables reloading or updating the context data coming from the KB 106 with the most up to date context—if necessary, avoiding any retraining or fine-tuning steps.

### C. Overview of Aspects of One or More Embodiments

### C.1 Introduction

There are various ways of processing context so that it can fit within the input constraints. These may be referred to as context management strategies, where efficiency usually relies on a good balance between the number of input tokens used and the amount of relevant information that is preserved to answer the query. Moreover, it is also important how these strategies deal with new inputs and previous information, particularly in their combination to fit within the maximum number of tokens available. For all possible scenarios, an embodiment may assume there is no one-size-fits-all strategy, especially where inputs are large and composed of multi-modal forms of data. For example, one strategy is the naïve summarization of textual information from all interactions, which works well to reduce its overall size of the context, that is, reducing the number of tokens used, but at the expense of discarding crucial parts, particularly if these inputs are extended to include pictures, videos, or voices.

Assuming a large and multi-modal input, one embodiment may comprise a context management architecture that subdivides the input into a number of chunks, automatically determines the best strategy for each chunk, applies the selected strategy, and combines the results with existing context. This approach permits the embodiment to run locally or fully distributed, allowing the serving system to balance the demand. This architecture may be useful in various contexts, for example:
An embodiment may be implemented in servers as an LLM optimizer. This would couple well with the orchestration aspect of running the architecture in a distributed use case, for example, a central node and set of edge devices.
Due to its capacity for load balancing, an architecture according to one embodiment may leverage other approaches to split LLM workloads into edge devices dynamically.
At the same time, an embodiment may be use in processes that include AI chatbots, enabling better management of corporate information and accurate information retrieval, especially for multi-modal information such as, for example, large documents, slide decks, and videos.

### C.2 General Aspects of One Example Embodiment

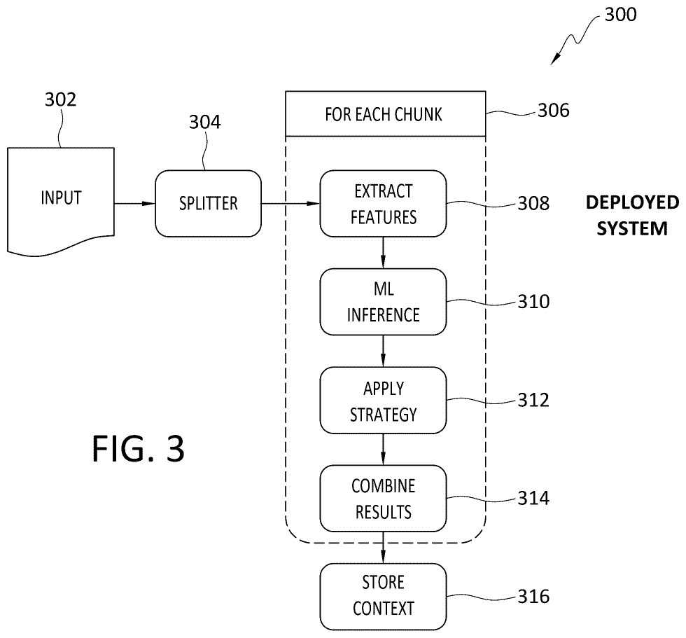

Following is a high-level discussion of an example embodiment. A more detailed description of an example embodiment then follows. With reference now to the example schema 300 of FIG. 3, one example embodiment may comprise the following processes and operations:
1. Process 1—given an input I 302, an embodiment may use a splitter 304, responsible for breaking up the input 302 into self-contained chunks of information, to generate a set of k chunks. Chunks may overlap with other chunks as long as each chunk is self-contained—for example, text-based chunks may be specific to each topic, but some content may be shared to maintain self-containment.
2. Process 2—for each chunk 306, an embodiment applies one of the following according to the scenario in which this approach is being applied:
   [Server only] The chunk features are extracted and encoded 3080 for the ML inferencing process 310. The resulting inference is used to select the best strategy —for example, a specific LLM for summarizing texts based on features present in their contents—which is applied 312 to the chunk. The result of this processing is then passed to the Process 3, discussed below.
   [Fully Distributed] The chunk is transmitted to an edge device. Features present in this chunk can also be used to transmit it into the most suitable edge device. Next, the chunk features are extracted and encoded 308 for the ML inferencing process 310. The resulting inference is used to select the best strategy, which is then applied 312 to the chunk. The result of this processing is then passed to Process 3, discussed below.
   [Mixed] A orchestrated combination of [Server] only and [Fully Distributed] scenarios. For example, depending on the load on the server, the chunk can be sent to an edge device or processed locally.
3. Once all results from the Process 2 are completed, a combinator is executed on these results along with an optional previous context. This step works by merging 314 all results into a single meaningful solution for all chunks. Optionally, a context can also be provided to the combinator to enhance the resulting solution. In a simple example, all chunks that were summarized in the Process 2 are then concatenated into a single document, which is then summarized by the combinator to produce a shorter but meaningful description of all chunks enriched by the previous context. The context resulting from the merging 314 may be stored 316.

### C.3 Further Discussion

As disclosed herein, one or more embodiments may possess various useful features and aspects, although no embodiment is required to possess any of such features or aspects. The following examples are illustrative, but not exhaustive.

An embodiment may comprise a contextualized summarization method. Various different summarization methods and configurations may be employed according to circumstances in which an embodiment may be employed. For example, a final application may select a more restrictive—such as less text, more concise, or open—more text, less concise, summarization strategy depending on the LLM used, the nature of the operating environment, and the structure and operation of the infrastructure, for example.

As another example, an embodiment may comprise a flexible pipeline-based architecture. An application of an embodiment may leverage the pipeline-based architecture by adjusting the granularity of chunks, which influences the final number of pipelines to be employed.

In a final example, an embodiment may implement and use an infrastructure-aware summarization architecture. In this approach, an existing infrastructure may decide about the parallelism level it will use by leveraging a splitter/chunk generation process. As the number of chunks and pipelines increase, it also opens the possibility of increasing the parallelization level.

### D. Detailed Discussion of Some Example Embodiments

### D.1 Introduction

There are multiple tools that can serve as components of an embodiment. For example, Langchain's CombineMemory [7] can combine multiple contexts with different strategies each, and Semantic Chunking [8] can split a piece of text into multiple semantically dissimilar chunks.

By way of contrast however, an embodiment comprises a complete and larger architecture which is believed by the inventors to be the first to offer the same combination of features disclosed herein. That is, at present, and absent any human intervention, there is no automatic approach that can partition the input, determine the best strategy, and combine the results with an optional context. In contrast with an embodiment, conventional tools are static in the sense of deciding the best strategy to the context management strategy, in other words.

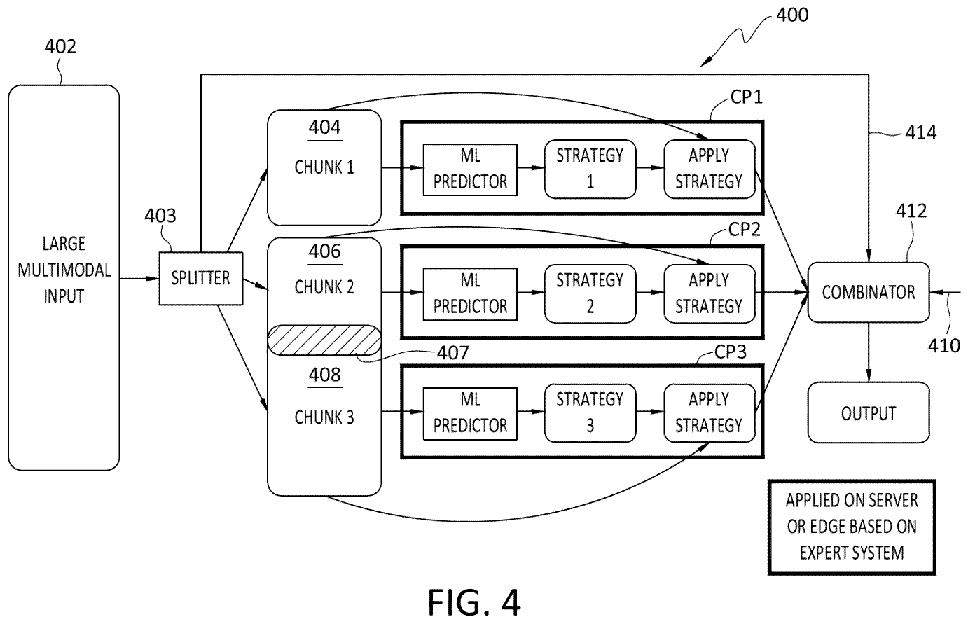

As explained earlier herein, one or more embodiments innovate in the context management area by [i] automatically splitting the input, [ii] determining the best summarization strategy for each chunk or segment, and [iii] combining the results with an optional previous context. In an embodiment, it may be assumed that the input is a large piece of data, potentially including multiple modalities such as, but not limited to, text, video, audio, and images. FIG. 4 discloses an overview example of a decision flow 400 according to one embodiment, from the input to the output.

It is noted that in the illustrative, but non-limiting, example of FIG. 4, the input 402 is partitioned by a splitter 403 into three chunks 404 (Chunk 1), 406 (Chunk 2), and 408 (Chunk 3), where the respective contents of 406 (Chunk 2), and 408 (Chunk 3), partially overlap, as shown at 407. It is noted further that that the, optional, previous context information 410 may be inserted into a combinator 412 with the result from each chunk and that the combinator 412 may then check any overlapping information from three chunks 404 (Chunk 1), 406 (Chunk 2), and 408 (Chunk 3), and the previous context 410 to avoid duplication. The combinator 412 may need to know how many chunks it needs to await. Thus, this information may be relayed 414 by the splitter 403 to the combinator 412. As shown in the example of FIG. 4, each ‘ML Predictor’ operates within a respective “chunk pipeline,” which are denoted at ‘CP1,’ ‘CP2,’ and ‘CP3.’ In an embodiment, each chunk pipeline can be independently executed locally, or in the edge/cloud. Any number of chunk pipelines may be used, and the scope of this disclosure is not limited to the particular embodiment disclosed in FIG. 4.

### D.2 Splitter

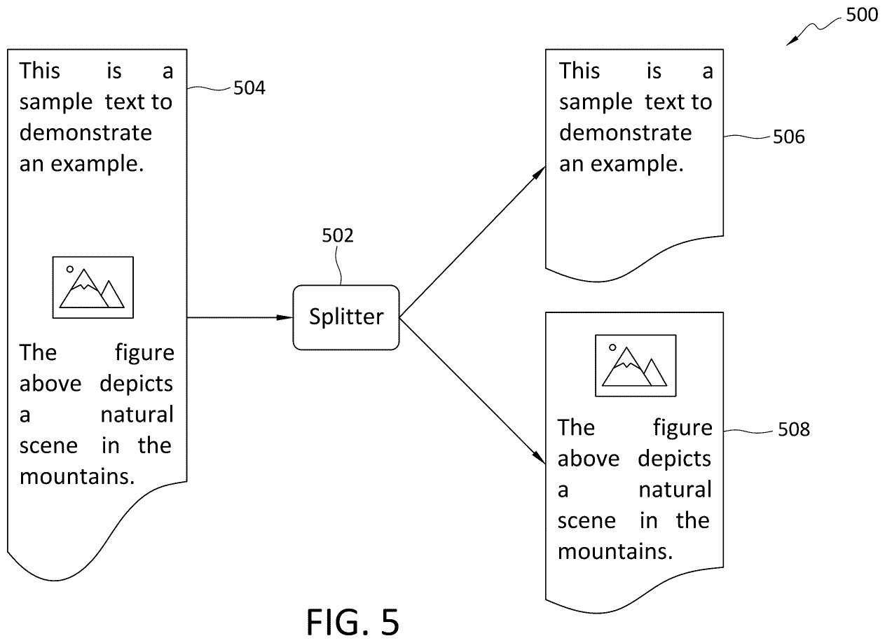

In one or more embodiments, and with reference now to the example schema 500 disclosed in FIG. 5, a splitter 502, which may comprise an LLM, operates to break the input 504 into self-contained chunks of information. Splitting can be done in different ways and some frameworks that are used to build LLM-based applications provide multiple splitters, from naïve and token-based splitters, to more advanced splitters that implement processes such as context-based splitting, that is, topic-aware splitting in which input is split on a topic basis. One example embodiment is splitter-agnostic as long as the splitter 502 is capable of breaking multi-modal and large input 504 into self-contained chunks 506 and 508. This is shown in FIG. 4 which discloses an example of splitting an input 504 into two independent semantic chunks 506 and 508. The chunks 506 and 508 do not need to be contiguous to each other in the input 504 and these chunks 506 and 508 may overlap each other in their respective content in order to keep each chunk 506 and 508 semantically consistent.

In an embodiment, the splitter 502 can provide chunks which are independent pieces of information replicated from the original input 504 or they can be ranges from which another process will gather the input pieces. As an embodiment, the splitter 502 might output “[Chunk 1: ‘range=[0,10], type=text’, Chunk_2: range=[5,15][20,30], type=text picture]” to determine that there are two chunks, one chunk textual from lines 0 to 10, and other chunk from lines 5 to 15 and from lines 20 to 30 which includes text and any pictures inside the range. Chunks must carry their order to help the combinator component.

To split the input 504 in semantic chunks 506 and 508, an approach according to one embodiment is to feed the input 504 to a multi-modal LLM of a splitter 502 along with a prompt asking to split the input in the prompt. More advanced approaches can fine-tune a LLM to do this specific task of partitioning the input into multiple chunks.

### D.3 Chunk Pipeline

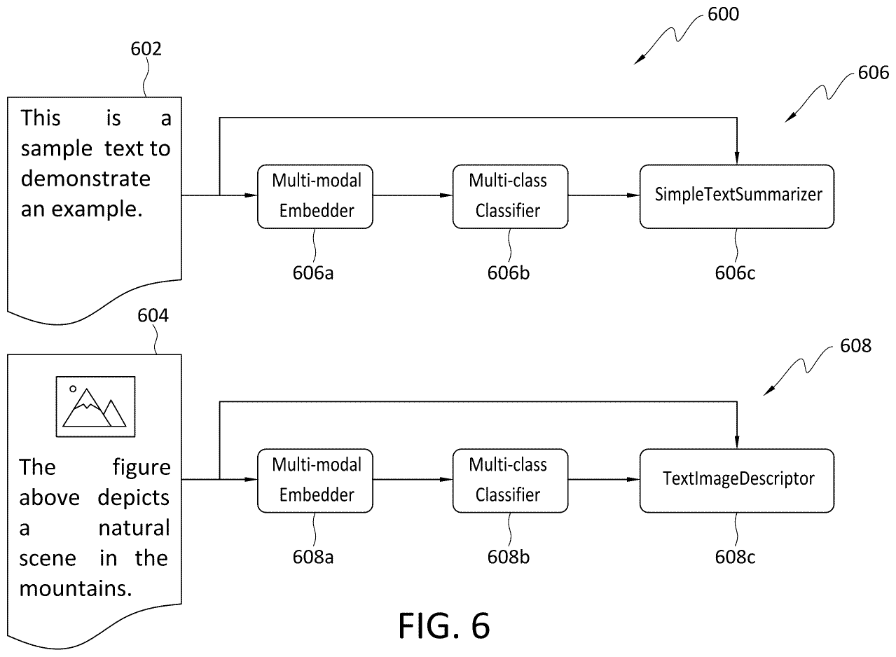

With reference now to FIG. 6, there is disclosed an example of a ML predictor flow 600 in which two chunks 602 and 604 are independently embedded and classified. The classifiers results are two different and fictitious context summarization strategies, or chunk pipelines, 603 and 605, respectively.

In an embodiment, a chunk pipeline comprises a series of operations to process a given chunk. In an embodiment, each arriving chunk triggers the following operations in a chunk pipeline:
1. receive a chunk and encodes its content to serve it as input to the ML predictor;
2. determine the best strategy to process the chunk based on the ML output;
3. apply the chosen strategy on the arriving chunk; and
4. relay the result to the combinator component.

The model of the ML predictor can use chunk features such as the number of tokens, number of figures, presence of other multimedia formats, language, as well as semantic aspects of the chunk content itself as an input layer of the model, which may be an LLM. The output of the ML predictor is the label, or anything that can serve as a label, associated with a strategy. In other words, the ML predictor can be embodied by any model capable of multiclass classification or even an online reinforcement learning (RL) approach. This could also be extended to an open-set classification approach to determine if no strategy can process a given chunk. In such scenarios, this could be signaled to the splitter to subdivide this chunk into smaller chunks to increase granularity in the data, enabling the predictor to provide a feasible strategy for each one.

Attention is directed now to one possible implementation of a chunk pipeline component that implements the functionalities and features enumerated above. In the example embodiment disclosed in FIG. 6, a discrete and independent chunk pipeline 606 and 608 may be implemented with respect to the chunks 602 and 604, respectively. In each of the pipelines 606 and 608, a respective multi-modal embedder 606a and 608a encodes the chunk 602 and 604, respectively, into the appropriate data feeding it to its subsequent input into a multi-class classifier 606b and 608b, respectively.

Next, once the predictor outputs a label to represent the best strategy, which in the example of FIG. 6 is exemplified as “SimpleTextSummarizer” strategy 606c or “Text/mageDescriptor” strategy 608c, depending on the chunk, the strategy is then applied to the corresponding chunk. In an embodiment, an instance of a chunk pipeline can be deployed in each edge device in mixed and fully distributed architecture models, as discussed elsewhere herein. In this example implementation, each instance must have a non-empty pool of context processing strategies. In an embodiment, the ML predictor may be trained on historical data labelled with the best strategy from this pool.

In an embodiment, a multi-modal embedder can take various forms, such as Meta's ImageBind [1]. For embodiments over the multi-class classifier, one can use a combination of traditional classifier or even a multi-label classifier [2]. The usage of a multi-label classifier can include the highest probability label output, that is, a greedy approach, as long as this probability is above a threshold, otherwise, the model can select a fallback summarization strategy that is guaranteed to work in most cases regardless its result quality.

With regards to the training of this model, that is, a model of a multi-modal embedder, a variety of methods may be employed. As an example, the method present in Section 6.1 of [3] can be employed. This method first builds a label network of a multi-labelled dataset and then embeds the network in a network embedder available in OpenNE library. From this, a regressor is used within a classification model to determine the predictions.

### D.4 Combinator

In an embodiment, a combinator may perform the following operations:
1. receive the number of chunks from the splitter;
2. optionally receive previous context information from the session and/or user;
3. await the processed chunks;
4. build a new context for that session using all processed chunks.

Since, in an embodiment, the processing of each chunk in a respective chunk pipeline is easily parallelizable, a combinator may provide asynchronous facilities and a buffer to receive each processed chunk and start the combination process once the processing of all expected chunks is concluded.

Combining multi-modal chunks is potentially more complex than simply concatenating texts in order. Such a combination may be supported by a specialized and possibly fine-tuned LLM to perform a semantic join operation, that is, semantic meaning and human-readability are kept in the combination of chunks. In the following pseudocode, the steps of a high-level description of a combinator according to one embodiment are described.

In particular, below is an example of the execution flow for a combinator. This version waits for all chunks and sorts them in order of splitting. For that, it assumes that there is information in each chunk that can be used to do so.

Algorithm for combining chunks...

| | Input: chunks, previous_context, number_of_chunks |
|---|---|
| | Output: combined_context |
| 1. | processed_chunks ← await(chunks) |
| 2. | processed_chunks ← sort(processed_chunks) |
| 3. | combined_context ← “” |
| 4. | for i in [1,...,number_of_chunks]: |
| 5. | combined_context ← semantic_join(combined_context, i) |
| 6. | end for |

return combined_context

With regards to the semantic_join operation in the algorithm above, there are various strategies that may be employed, from simple merging to detection of repeated information in possibly overlapping chunks and removing this information or, alternatively, increasing its importance. As long as the output is a single context, this operation can range in complexity depending on the particular use-case and its requirements.

In another example for a combinator, the algorithm may preemptively start the chunk combination without waiting for all processed chunks. This would impact the final quality as out-of-order chunk arrival may require reprocessing of existing context, but it can be useful if the combined context needs to be ready in a certain amount of time due to any imposed SLO (service level objective) requirements. Another example embodiment leverages the fact that the disclosed architecture is not limited by text-only contexts, allowing that approaches such as Deep Semantic Image Compression [4] can be straightforwardly employed to compress images, for example, while preserving their original meaning.

### D.5 Orchestration and Distributed Aspects

As disclosed herein, one or more embodiments have three possible modes of operation regarding where each chunk pipeline ought to be processed: Server Only, Fully Distributed, or Mixed. The Server Only mode operates with all chunk pipelines locally despite the final output being kept in the server, or not. This mode is the mode that burdens the server the most, that is, insofar as it involves the centralization of all processes, but may be preferred if data privacy concerns or compliance requires all processing to be done on premises.

The Fully Distributed mode according to an embodiment works in an opposite direction compared to the Server Only mode, as all chunks are firstly sent to the edge devices and, after all the edge devices process their respective chunk pipelines and send back to the server, all results are combined in the server. Embodiments of this mode may consider that the server does not wait for all chunks to arrive, but just those that finished before a pre-determined amount of time. This mode is interesting when SLO requirements are imposed at all costs and low-quality combinations are allowed.

Finally, the Mixed mode according to an embodiment combines the benefits of parallelizing both modes, that is, the Fully Distributed mode and the Server Only mode, in a dynamic way, that is, the server can load balance which chunks which are eligible to be sent to edge devices. In the mixed mode, the server can send more chunks to the edge according to its current demand, where, for example, if the server demand is high or there is a higher chance of not complying with the SLO, the server may perform a load balancing and send a number of chunks to be solved in the edge while the remaining chunks will be processed by the server itself.

A more robust scenario may consider that the server pre-evaluates the computational effort to solve each chunk before sending to the edge. To do this evaluation, the server may use chunk features such as size, the number of figures or other multimedia objects for example, on a side ML predictor. In more specific scenarios, the server may send chunks to the edge only when allowed given input metadata specifying local processing only, for example, when there are special keywords in the input such as “CONFIDENTIAL” or a ML model classifies content as confidential.

As noted earlier herein, an embodiment of a combinator can also speed up the whole processing if, for example, some externally processed chunks are taking too long to process and the combinator, to comply with the SLO, may skip those remaining chunks. In one example embodiment, the splitter may add metadata related to the chunk. With this metadata, an ordering based on priority can be defined that may be used by the combinator. To add such metadata, the splitter must detect the relevancy of the chunk with regards to the whole input, that is, less important chunks will be skipped if the SLO is violated.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method, comprising: receiving input data; splitting the input data into a set of semantic chunks; for each of the semantic chunks, performing operations comprising: extracting features from the semantic chunk; using the features to perform an ML (machine learning) inferencing process that identifies a summarization strategy for summarizing the semantic chunk based on the features; and applying the summarization strategy to the semantic chunk to obtain a summary of the semantic chunk; and combining the respective summaries of each of the semantic chunks so as to define an overall context of the input data.

Embodiment 2. The method as recited in any preceding embodiment, wherein the input data is received from a user by an LLM (large language model) that is operable to generate a response to the user based on the context for the input data.

Embodiment 3. The method as recited in any preceding embodiment, wherein the input data comprises multimodal data.

Embodiment 4. The method as recited in any preceding embodiment, wherein the operations are performed, in parallel, in a respective pipeline for each semantic chunk.

Embodiment 5. The method as recited in any preceding embodiment, wherein each of the semantic chunks are transmitted to an edge device where the operations for that semantic chunk are performed.

Embodiment 6. The method as recited in any preceding embodiment, wherein the operations for each semantic chunk are performed at a single server.

Embodiment 7. The method as recited in any preceding embodiment, wherein the operations for each semantic chunk are performed either at an edge device or a server, and whether the operations are performed at the edge device or the server is determined based on one or more specified criteria.

Embodiment 8. The method as recited in any preceding embodiment, wherein a granularity of the semantic chunks is selected based on one or more specified criteria.

Embodiment 9. The method as recited in any preceding embodiment, wherein the summarization strategy is a best summarization strategy as among multiple different summarization strategies available to be applied to the semantic chunk.

Embodiment 10. The method as recited in any preceding embodiment, wherein the respective summaries are combined with previous context to define the overall context.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

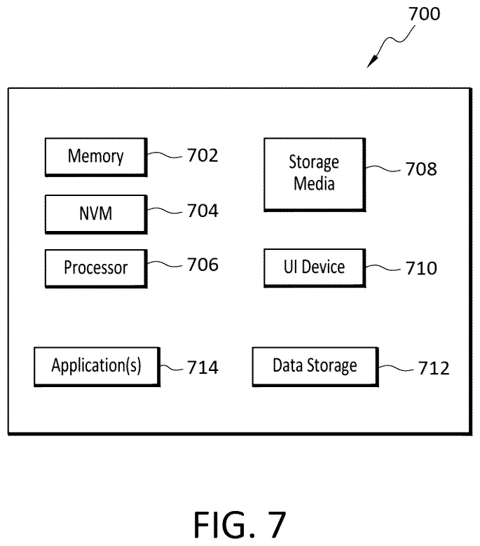

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

1. A method, comprising:
receiving input data comprising multimodal content for use as context input to a large language model (LLM);
splitting, by a splitter, the input data into a set of semantic chunks, each semantic chunk including order information of a range of chunk order within the input data;
for each of the set of semantic chunks, parallelly performing, by a respective chunk pipeline, operations comprising:
extracting and encoding chunk features to select, from a plurality of available context processing strategies, a respective summarization strategy for summarizing the semantic chunk based on the extracted and encoded features; and
applying the selected summarization strategy to the semantic chunk to generate a result of the semantic chunk;
buffering, by a combinator, results received from chunk pipelines;
sorting, by the combinator, the buffered results according to the order information;
semantically combining, by the combinator, the sorted results of each of the semantic chunks so as to define an overall context of the input data;
storing the overall context; and
generate a response by the LLM based on the overall context for the input data,
wherein semantically combining comprises:
detecting repeated information in overlapping chunks; and
removing the repeated information.

2. (canceled)

3. The method as recited in claim 1, wherein the input data comprises multimodal data.

4. The method as recited in claim 1, wherein the operations are performed, in parallel, in a respective pipeline for each semantic chunk.

5. The method as recited in claim 1, wherein each of the semantic chunks are transmitted to an edge device where the operations for that semantic chunk are performed.

6. The method as recited in claim 1, wherein the operations for each semantic chunk are performed at a single server.

7. The method as recited in claim 1, wherein the operations for each semantic chunk are performed either at an edge device or a server, and whether the operations are performed at the edge device or the server is determined based on one or more specified criteria.

8. The method as recited in claim 1, wherein a granularity of the semantic chunks is selected based on one or more specified criteria.

9. The method as recited in claim 1, wherein the summarization strategy is a best summarization strategy as among multiple different summarization strategies available to be applied to the semantic chunk.

10. The method as recited in claim 1, wherein the respective summarization strategies are combined with previous context to define the overall context.

11. A non-transitory storage medium having stored therein instructions that are executable by one or more hardware processors to perform operations comprising:
receiving input data comprising multimodal content for use as context input to a large language model (LLM);
splitting, by a splitter, the input data into a set of semantic chunks, each semantic chunk including order information of a range of chunk order within the input data;
for each of the set of semantic chunks, parallelly performing, by a respective chunk pipeline, further operations comprising:
extracting and encoding chunk features to select, from a plurality of available context processing strategies, a respective summarization strategy for summarizing the semantic chunk based on the extracted and encoded chunk features; and
applying the selected summarization strategy to the semantic chunk to generate a result of the semantic chunk;
buffering, by a combinator, results received from chunk pipelines;
sorting, by the combinator, the buffered results according to the order information;
semantically combining, by the combiner, the sorted results of each of the semantic chunks so as to define an overall context of the input data; and
storing the overall context; and
generate a response by the LLM based on the overall context for the input data,
wherein semantically combining comprises:
detecting repeated information in overlapping chunks; and
removing the repeated information.

12. (canceled)

13. The non-transitory storage medium as recited in claim 11, wherein the input data comprises multimodal data.

14. The non-transitory storage medium as recited in claim 11, wherein the operations are performed, in parallel, in a respective pipeline for each semantic chunk.

15. The non-transitory storage medium as recited in claim 11, wherein each of the semantic chunks are transmitted to an edge device where the operations for that semantic chunk are performed.

16. The non-transitory storage medium as recited in claim 11, wherein the operations for each semantic chunk are performed at a single server.

17. The non-transitory storage medium as recited in claim 11, wherein the operations for each semantic chunk are performed either at an edge device or a server, and whether the operations are performed at the edge device or the server is determined based on one or more specified criteria.

18. The non-transitory storage medium as recited in claim 11, wherein a granularity of the semantic chunks is selected based on one or more specified criteria.

19. The non-transitory storage medium as recited in claim 11, wherein the summarization strategy is a best summarization strategy as among multiple different summarization strategies available to be applied to the semantic chunk.

20. The non-transitory storage medium as recited in claim 11, wherein the respective summarization strategies are combined with previous context to define the overall context.
